(19) United States
(12) Patent Application Publication
(10) Pub. No.: US 2011/0197465 A1
(43) Pub. Date: Aug. 18, 2011

(54) METHODS FOR WATER REMOVAL

(75) Inventors: LUCIA JIENSUK BYRNE, BLOOMINGTON, MN (US); JERRY DEAN HOYT, HASTINGS, MN (US); STEPHEN JAMES ENGEL, ROSEMOUNT, MN (US); DARREN MICHAEL JAHNKE, LONSDALE, MN (US)

(73) Assignee: ECOLAB USA INC., St. Paul, MN (US)

(21) Appl. No.: 12/706,143

(22) Filed: Feb. 16, 2010

(51) Int. Cl. F26B 5/00; C11D 3/37

(52) U.S. Cl. 34/282; 510/513

(57) ABSTRACT

A water removal composition and methods for using the same to remove excess water from a surface. The composition comprises a silicone polymer, quaternary ammonium emulsifier, co-emulsifier and an HLB stabilizing agent that modifies a treated surface to form a continuous hydrophobic layer enhancing water removal from the surface. The novel water removal compositions and methods for using the same result in a significant reduction of energy expenditure to remove excess water through air blowers and/or mechanical removal.

### FIELD OF THE INVENTION

The invention relates to a water removal polymer composition and methods for using the same to remove excess water from a treated surface. The water removal composition can be used during the rinsing or dewatering of a variety of surfaces. Such surfaces can include exterior vehicle surfaces which can be made of painted surfaces, thermal plastic composite surfaces, metal, glass, rubber, steel and aluminum wheels, plastic panels and trim pieces. In particular, the composition and methods removes water from surfaces reducing the need for energy input to dry such surfaces.

### BACKGROUND OF THE INVENTION

Hydrocarbon oils have commonly been applied to vehicle surfaces after a vehicle is cleaned to promote a shiny finish and assist with removing water from the vehicle surfaces. However, use of hydrocarbon oils or other dewatering or drying agents do not provide sufficient water removal after a surface is rinsed. Vehicles still require the expensive use of automated blowers to remove excess water. Accordingly, there remains a significant need to reduce the use of blowers for drying commercial or industrial vehicles in semi-automatic and automatic carwashes. Although blowers are moderately effective in removing liquids from a vehicle's surface, such blowers are costly to operate and maintain. The energy costs to dry a car can rival the total cost to clean and apply polish to a car as it is estimated that one-half of carwash operational costs are spent on energy alone to power the automated blowers used to dry cars. On average, carwashes use in excess of 150 Hp of blower energy to remove water during a drying cycle when using up to 10-15 blowers (approximately 15 Hp each).

In addition to the costly use of automated blowers to dry vehicles, often expensive drying agents are utilized to remove water from vehicles. Despite the use of such drying agents and automated blowers, without the additional use of manual wiping, the prior art demonstrates these methods still fail to produce an exceptionally dry vehicle. In addition, carwashes often result in spotting and streaking on cars due to water run-off and incomplete drying.

Various vehicle cleaning, rinsing and dewatering compositions have demonstrated success in the marketplace. Hei et al., U.S. Pat. No. 5,871,590 disclose a touchless carwash composition for cleaning and drying comprising a fatty alkyl ether amine in place of a silicone and hydrocarbon wax material. Lemin et al., GB 2,036,783 disclose a water-repellent foam using a cationic dewatering agent comprising an ethoxylated amine that can also use an optional anti-static agent. Tarr, U.S. Pat. No. 5,221,329 discloses a water repellent material used as a coating for aircraft comprising a quaternary ammonium compound and a saline compound. Nagy et al., U.S. Pat. No. 6,780,828 disclose the use of isobutylene and copolymers for use as hydrophobes to dry surfaces. Despite these and numerous other compositions and methods utilized in commercial processes to dewater and dry surfaces, such as vehicles, there remains a continued need to improve upon the ability, in particular the ability of the rinsing and dewatering compositions, to develop compositions capable of improved drying of surfaces without causing spotting and/or streaking due to water run-off.

Accordingly, it is an objective of the claimed invention to develop methods and compositions for significantly reducing energy costs for drying surfaces, such as using blowers to dry cars in automated carwashes.

A specific object of the invention is a targeted energy reduction of at least 40% in drying of cars due to the development of a water removal composition.

A further object of the invention includes methods and compositions for chemically drying surfaces without the use of blowers and/or manual labor to dry surfaces.

A still further object of the invention includes methods and compositions for providing a hydrophobic treatment to chemically dry surfaces utilizing the Lotus-Effect.

### BRIEF SUMMARY OF THE INVENTION

A water removal composition for reducing energy necessary to dry surfaces, such as in carwashes, is described. The composition is applied after a surface is rinsed to form a continuous, hydrophobic polymer layer to enhance water removal with reduced mechanical action. Methods of using the water removal composition for aiding in enhanced water removal from a surface is further disclosed. The water removal composition comprises a silicone polymer, quaternary ammonium cation, emulsifier and stabilizing agent.

### BRIEF DESCRIPTION OF THE DRAWINGS

FIG. 1 shows comparative effectiveness of the silicone polymer emulsion (LB5) in a Chemical Dip Test against benchmark drying agent Blue Coral Cold Wax (CW) and CSI® drying agent Lustra Pearl® (Comp) tested with soft water.

FIG. 2 shows comparative effectiveness of the silicone polymer emulsion (LB5) in a Chemical Dip Test against benchmark drying agent Blue Coral Cold Wax (CW) and CSI® drying agent Lustra Pearl® (Comp) tested with 17 gpg water.

FIG. 3 shows comparative effectiveness of the silicone polymer emulsion (LB5) in Flat Panel Sheeting Test at 5 seconds against benchmark drying agent Blue Coral Cold Wax (CW) and CSI® drying agent Lustra Pearl® (Comp) tested with soft water.

FIG. 4 shows comparative effectiveness of the silicone polymer emulsion (LB5) in Flat Panel Sheeting Test at 15 seconds against benchmark drying agent Blue Coral Cold Wax (CW) and CSI® drying agent Lustra Pearl® (Comp) tested with soft water.

FIG. 5 shows comparative effectiveness of the silicone polymer emulsion (LB5) in Flat Panel Sheeting Test at 5 seconds against benchmark drying agent Blue Coral Cold Wax (CW) and CSI® drying agent Lustra Pearl® (Comp) tested with 17 gpg water.

FIG. 6 shows comparative effectiveness of the silicone polymer emulsion (LB5) in Flat Panel Sheeting Test at 15 seconds against benchmark drying agent Blue Coral Cold Wax (CW) and CSI® drying agent Lustra Pearl® (Comp) tested with 17 gpg water.

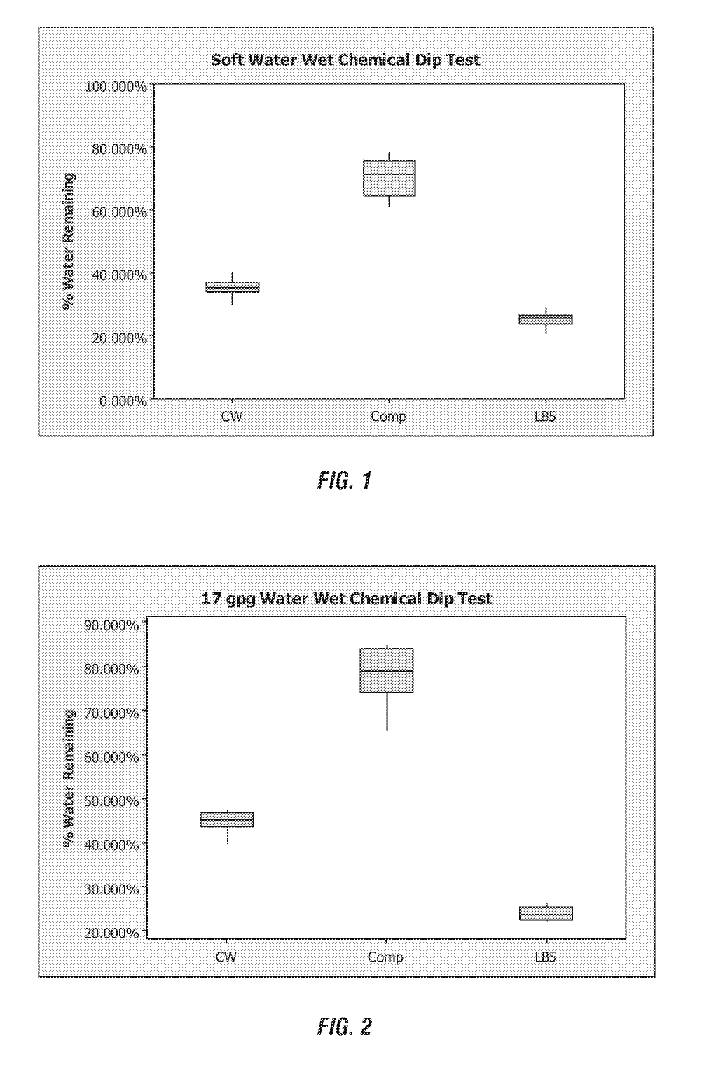

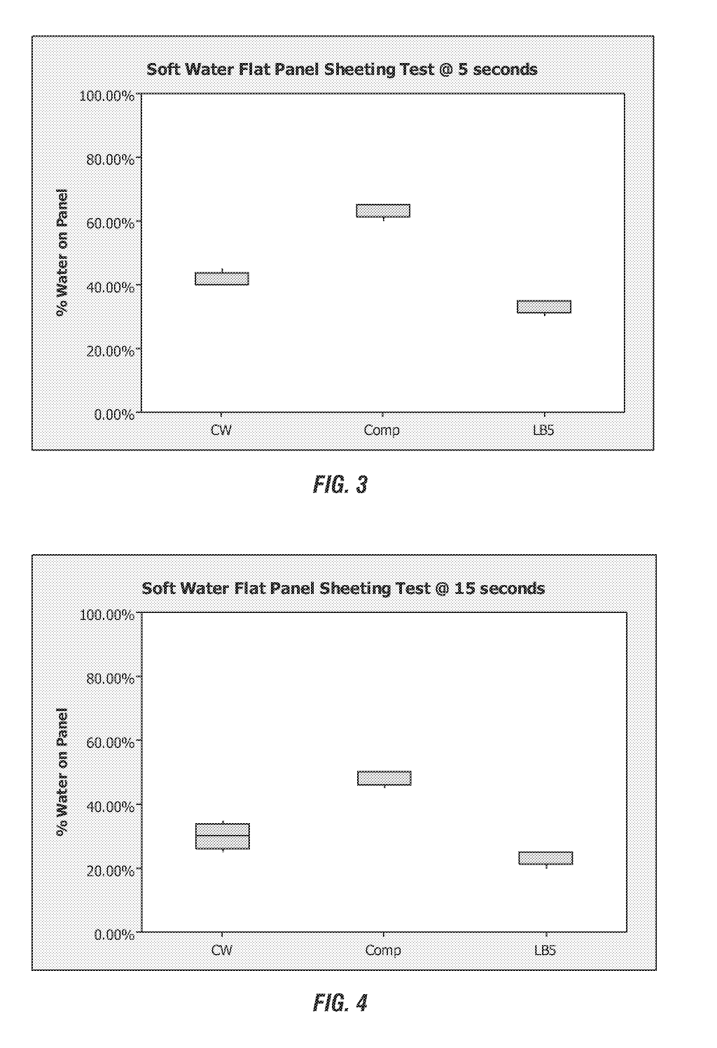

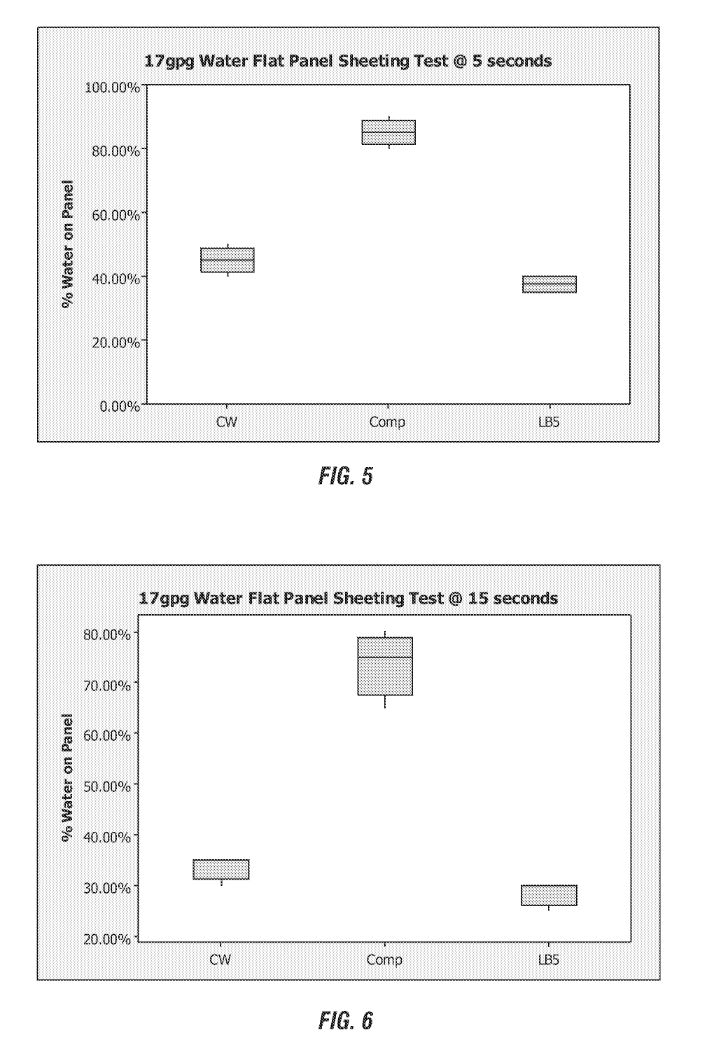

### DETAILED DESCRIPTION OF THE PREFERRED EMBODIMENT

The embodiments of this invention are not limited to particular water removal treatment methods and compositions, which can vary and are understood by skilled artisans. It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers defining the range and include each integer within the defined range.

Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities refers to variation in the numerical quantity that can occur.

The term “microemulsion” as used herein, refers to a thermodynamically stable liquid dispersion of one liquid phase into another that is stabilized by an interfacial film of surfactant. According to the invention, the microemulsion forms an interface with the surfactant between the two immiscible phases of oil and water.

The terms “vehicle” or “car” as used herein, refer to any transportation conveyance including without limitation, automobiles, trucks, sport utility vehicles, buses, trucks, motorcycles, monorails, diesel locomotives, passenger coaches, small single engine private airplanes, corporate jet aircraft, commercial airline equipment, etc.

The terms “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The water removal compositions and methods according to the embodiments of the invention represent a significant improvement in the prior art and in various industries, namely the carwash industry. The water removal compositions and methods result in a marked decrease in the need for energy expenditure to either mechanically or manually dry treated surfaces. The compositions according to the invention are more than mere dewatering or drying agents; rather, the compositions create a continuously hydrophobic surface that rapidly drains liquids from the surface with little to no aqueous residue. The compositions are further able to overcome wetting agents frequently applied to washed surfaces, such as during a carwash, resulting in a significant reduction in water remaining on treated surfaces and thereby reducing or eliminating the need for energy to dry the surface. This not only reduces the use of high-energy automated blowers, but also reduces the labor costs of manually drying the treated surfaces.

According to an embodiment of the invention, a water removal composition and methods for using the same are described for use on a variety of surfaces. The treated surfaces preferably include any exterior vehicle surface, such as painted surfaces, thermal plastic composite surfaces, metal, glass, rubber, steel and aluminum wheels, plastic panels and trim pieces. Preferably, exterior surfaces of a vehicle are treated with the water removal composition after rinsing and prior to the drying step of a carwash. The composition serves as a water removal polymer on top of the exterior surface to effectively overcome remaining wetting agents and detergents and cause the removal of excess water used to rinse the exterior vehicle surfaces.

According to alternative embodiments of the invention, the water removal composition and methods provided herein may be utilized in a variety of settings wherein a hydrophobic or hydrophilic, continuous layer on a surface is desired to remove excess water, including, for example: institutional uses for shining and drying aids and/or hard surface treatment; laundry and textile treatments to create water resistant and/or water-proof surfaces; food and beverage services for use as a drying aid for warewash applications, as accommodated by the GRAS rating of the silicone polymers according to the invention; and/or consumer markets, such as home use as a shining and drying aid on surfaces such as for hydrophobic glass treatments. As a result of the various alternative embodiments according to the invention, the water removal compositions and methods may further be used on surfaces in addition to vehicles, including, for example, countertops and other solid surfaces (particularly metal surfaces), and/or glass.

According to an embodiment of the invention, surfaces treated with the water removal composition demonstrate superior water removal ability compared to benchmark dewatering and drying agents and competitive products. This is a result of the water removal composition's ability to modify a treated surface, preferably a nearly flat surface, to leave a continuous layer of silicone polymer composition on the surface to release increased amounts of water from such surface. The water removal composition according to the invention works by creating either a highly hydrophilic or hydrophobic surface to remove excess water. According to a preferred embodiment, the surface is modified to create a continuously hydrophobic surface that removes water and does not retain residue on the surface. Unlike prior methods and compositions, where water beads on treated surfaces and is not released completely, a continuous surface is created according to the invention to utilize a Lotus-effect technology to remove water from the treated surface by creating ultra-high contact angles. However, this beneficial result occurs regardless of whether hydrophobic or hydrophilic surfaces are created. This is distinct from prior art relying upon hydrophobic surfaces having lesser interfacial tensions between a hydrophobic surface and a liquid that forms droplets and beads. See e.g., Nagy et al., U.S. Pat. No. 7,388,033.

The water removal composition further demonstrates the ability to overcome commonly-used surface-wetting surfactants or detergents applied to vehicles in commercial carwashes, in order to contact the surface and create the surface modification described herein. Surface-wetting surfactants are frequently applied to surfaces in the form of detergent-laced solutions to remove soils; however, the surfactants also act to impede the vehicle's ability to remove water due to its hydrophilic qualities. When a surface treated with a surfactant is not completely dried there often remains traces of detergent residue. As a result, the use of prior art drying agents demonstrates that only a portion of the prior art drying agent reverses the wetting effect to a releasing effect, reducing drying effectivity of the product.

According to the water removal composition of the invention, the composition overcomes any detergent or its residue, causing the visual dissipation of the detergent (often present in the form of foam on the surface) and reaches the surface, creating a continuous, hydrophobic layer causing the removal of water from the surface. According to a preferred embodiment, the continuous, hydrophobic layer results in any water or other solutions contacting the treated surface to be quickly removed.

According to the methods of water removal of the invention, a surface is treated with the water removal composition to increase liquid removal to reduce the energy required to remove water. According to a preferred embodiment, the water removal composition is applied to the surface after the wash step and prior to the final rinse of the surface. For example, according to a preferred embodiment, the water removal composition is applied to a vehicle's exterior surface during the carwash, preferably in the final stages of the carwash process. According to a further embodiment of the invention, the water removal composition is added to the final rinse or prior to the final rinse in a concentration of approximately 0.1-1%, more preferably approximately 0.125-0.4%, and most preferably between approximately 0.167-0.250% for use as a surface treatment for water removal.

The use of the water removal compositions according to one embodiment of the invention results in the creation of a hydrophobic, continuous film causing the removal of excess water from the rinsed surface and allows any water remaining on the surface to be easily removed with either minimal mechanical action or air impingement automated blowers. According to an embodiment of the invention, the water removal compositions are applied each time the surface is washed and rinsed; for example, if used to enhance drying of a vehicle in a carwash, the water removal composition is applied on a per car wash basis.

In addition to the methods for using the water removal compositions according to the invention, preferred compositions for treatment of suitable surfaces are provided. According to a preferred embodiment of the invention, the water removal composition comprises a silicone polymer, quaternary ammonium emulsifier, co-emulsifier and stabilizing agent. The compositions of the preferred water removal composition are expressed in weight percent, unless otherwise stated. Suitable component compositions are set forth below with preferred ranges of the compositions also set forth:

| Water Removal Composition | Wt % | Preferred Wt % |
|---|---|---|
| Silicone polymer | 0.05-20% | 1-10% |
| Quaternary ammonium emulsifier | 10-40% | 10-35% |
| Co-emulsifier | 1-20% | 2-17% |
| HLB stabilizing agent | 1-15% | 1-10% |

These percentages can refer to percentages of a commercially available water removal composition, which may further a variety of other materials useful in the manufacture of a water removal composition, including solvents, dyes, thickening agents, pH modifiers, shine enhances, odorants, colorants and others in addition to the silicone polymer, quaternary ammonium emulsifier, co-emulsifier and stabilizing agent of the water removal composition. Those skilled in the art will appreciate other suitable component concentrations for obtaining comparable water removal properties on treated surfaces described herein.

The water removal composition according to the invention is an emulsion, more preferably a microemulsion. The water removal composition may be a dispersion of oil-in-water (o/w) or water-in-oil (reversed, w/o) to combine the two immiscible phases with a surfactant to form an interface. The microemulsion according to the invention forms upon combining or mixing of the composition's components without the requirement for any high shear conditions often used to create emulsions. According to a preferred embodiment of the invention, the water removal composition is formed of micelles holding the hydrophobic active drying agent. Additionally, the water liquid phase is intimate with the treated surface such that the hydrophobic active drying agent is able to be immediately released to such surface.

The polymer of the water removal composition may be of any structure functional with the water removal composition. According to a preferred embodiment of the invention, the polymer is a hydrophobic silicone polymer, chosen from silicone polymers having a high molecular weight to ensure a more stable microemulsion is formed. In addition, the use of a high molecular weight polymer enhances the polymer's ability to cause water to create a contact angle of approximately >105° or <20°. According to a further preferred embodiment of the invention, the polymer is a polydimethylsiloxane having the general formula (H₃C)₃SiO[Si(CH₃)₂O]ₙSi(CH₃)₃ shown below:

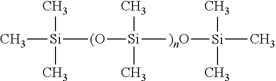

An example of a suitable polydimethylsiloxane is Dow Corning 200 Fluid 350 CST, commercially available from Dow Corning Corp. (Midland, Mich.). The silicone polymer may further be selected from the following: amino-functional surface active silicones, a hydrophobic silicone polysiloxane, a hydrophobic silicone polysiloxane copolymer, a hydrophilic polyalkylene oxide-modified polydimethylsiloxane, a hydrophilic polybetaine-modified polysiloxane or combinations of the same. The silicone polymer of the water removal composition causes water to bead- or sheet-off the treated surface and retains a shiny surface due to the high refractive index and contact angle.

The quaternary ammonium emulsifier of the water removal composition is capable of forming a uniform layer over the treated surface due to attraction to the residual negative charge present on a vehicle surface after it is washed. Accordingly, the quaternary ammonium emulsifier of the water removal composition produces a continuous coating upon the surface by electrostatic attraction due to the protonation of the amino groups, providing a continuous layer over the surface. The quaternary ammonium emulsifier also acts as a surfactant to maintain the various chemical components of the water removal composition in an emulsion. According to the invention, cationic surfactants are suitable for the water removal composition. According to an embodiment of the invention, a preferred quaternary ammonium emulsifier is a cationic dicoco quat that provides high beading- or sheeting-off of water on the surface. An example of a suitable quaternary ammonium cation emulsifier is Carspray™ 300, available from Evonik. Further examples of suitable commercially-available quaternary ammonium emulsifiers include Emulsifier 300, available from Air Products and Chemicals, Inc., and Arquat 2C-75, available from Akzo-Nobel.

The co-emulsifier of the water removal composition is an agent capable of enhancing the stability of a microemulsion. The co-emulsifier further acts to create a bridge effect, forming a continuous silicone polymer surface with the quaternary ammonium emulsifier to aid water removal from the treated surface by releasing and rejecting water due to the high contact angle. According to an embodiment of the invention, a preferred co-emulsifier is an anionic surfactant such as an ethoxylated amine or combination of ethoxylated amines. Various ethoxylated amines or fatty amine salts may be utilized according to the invention. Examples of suitable ethoxylated amine are Tomamine E-14-5, Tomamine E-17-5 and Tomamine E-DT-3, available from Air Products and Chemicals, Inc. According to a further embodiment, the ethoxylated amine of the invention is selected to mimic the hydrophilic lipophilic balance (HLB) of the silicone polymer of the water removal composition. The co-emulsifier according to the invention utilizes the HLB to select components capable of emulsifying or solubilizing the components of the water removal composition. The greater the HLB, the more water soluble an emulsifier; whereas the lower the HLB the more oil soluble the emulsifier.

According to another embodiment, the ethoxylated amine co-emulsifier stabilizes the quaternary ammonium emulsifier and results in synergistic effects between the quaternary ammonium emulsifier and the stabilizing agent, preferably a tallow diamine. According to the invention, the tallow diamine is more lipophilic than the quaternary ammonium emulsifier, such as a dicoco-quaternary amine. Upon blending the two in varying ratios an HLB that best satisfies the lipophilic nature of the silicone polymer of the water removal composition. The water removal composition according to the invention provides a lipophilic/hydrophilic combination to provide a stable oil-water microemulsification system.

The HLB stabilizing agent of the water removal composition is an agent capable of stabilizing the water removal composition to achieve improved stability of the microemulsion and prevent phase separation of the silicone polymer. The HLB stabilizing agent may further act as an auxiliary emulsifier for the microemulsion. The HLB stabilizing agent still further acts to create the bridge effect of the water removal composition. According to an embodiment of the invention, a preferred stabilizing agent is a fatty amine, such as a tallow amine. According to a more preferred embodiment, the fatty amine is a tallow diamine (N-ethylpropane-1,3-diamine). An example of a suitable stabilizing agent is Tomamine E-DT-3, available from Air Products and Chemicals, Inc., and Ethomeen T-12, available from Akzo-Nobel.

The water removal composition of the invention may further include a carrier or combination of carriers. The carrier provides a medium which may dissolve, suspend, or otherwise carry the other components of the microemulsion. In certain embodiments, the carrier includes primarily water which can promote stability of the microemulsion and work as a medium for reaction and equilibrium. The carrier can also include or be primarily an organic solvent. An example of a suitable carrier is Cellosolve™. A skilled artisan may ascertain various additional suitable carriers for use in the invention. See Man et al., U.S. Pat. No. 7,569,232.

The various embodiments of the water removal composition of the invention are utilized for treating a variety of surfaces requiring the removal of excess water, rather than using expensive and high energy drying systems, such as automated blowers. The composition for removing water from a surface according to the invention may be provided in a concentrated form which, when dispensed or dissolved in water, properly diluted by a proportionating device, and delivered to the target surfaces as a microemulsion will provide effective water removal treatment of a surface. According to an alternative embodiment of the invention, the water removal composition may further comprise a diluent or mixture of diluents.

As a skilled artisan would recognize, ordinary tap water (approximately 6-9 gpg), softened water (approximately 0 gpg) or process water may be employed. Further, the water may be softened or unsoftened, distilled, ion exchanged, undergone reverse osmosis and the like. According to a preferred embodiment, the water removal composition may be used with water up to about 17 gpg, preferably up to about 8 gpg, and retain its effectiveness as a water removal agent for treated surfaces. According to a further embodiment, the water removal composition is used with water having a calcium to magnesium ratio greater than 3.

The water removal composition according to the invention is also compatible with additional agents commonly used to treat surfaces described in the invention. For example, the water removal composition is compatible with various vehicle protectants, such as Rain-X®. According to the invention, the compatibility of the water removal composition with additional vehicle protectants is unexpected as many underbody inhibitors or anionic conditioning products are not often compatible with water removal chemistries. Additionally, according to the invention, the composition is compatible with and may be formulated to further include additional optional chemicals in varying concentrations as individual needs may require, which are not critical to the performance of the composition for water removal. For example, it may be desirably to include soil resistant/protectant agents, corrosion inhibitors, dyes, optical brighteners, shine enhancers, odorants and the like.

The compositions of the invention may also contain an acidic or basic material capable of altering the composition's pH to be close to neutral, for example from approximately 5-8. A variety of typically mild acids may be used to neutralize the conditions of the water removal composition and its application to a basic surface due to prior exposure to a detergent during the washing process. Examples of such acidic materials may include, for example, acetic acid or other suitable carboxylic acids, hydroxyacetic acid, citric acid and other acids commonly used in the formulation of cleaning compositions. An example of a suitable acid is Glacial Acetic Acid, a carboxylic acid, available from BP Chemicals, Inc. It may be further desirable to add additional agents for specialized uses of a surface as may be ascertained by those of ordinary skill in the art.

The water removal composition of the invention may be made using a variety of mixing processes. The components of the water removal composition, including the silicone polymer, quaternary ammonium emulsifier, co-emulsifier and HLB stabilizing agent and any other suitable chemicals are mixed together to create a final formulation. The water removal composition may be diluted before its application. According to a preferred embodiment of the invention, the preferred components of the composition, including the silicone polymer polydimethylsiloxane, cationic dicoco quat, ethoxylated amine, tallow diamine and any other suitable chemicals are mixed together to create a final formulation for use as described herein.

According to a still further preferred embodiment, the concentrated form of the composition may be delivered in a dual-feed system, for combination immediately prior to use on the treated surface. Such separate storage of the water removal composition's silicone polymer from the quaternary ammonium emulsifier, co-emulsifier and HLB stabilizer will enhance the stability of the microemulsion. For example, the silicone polymer may be added last to the water removal composition at a sufficiently slow rate to form a microemulsion stable for at least up to 24 hours once combined. As one skilled in the art may ascertain, a variety of mixing methods may be employed (such as automated or manual dilutions) in order to utilize a dual-feed methodology according to the invention and depending on the specific needs of the particular operation.

All publications and patent applications in this specification are indicative of the level of ordinary skill in the art to which this invention pertains. All publications and patent applications are herein incorporated by reference to the same extent as if each individual publication or patent application was specifically and individually indicated by reference.

### Examples

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Example 1

WET CHEMICAL DIP TEST: The ability of a water removal composition was tested to determine its effectiveness as a drying agent, particularly for use in a car wash. The composition's ability to increase the shedding of water from a surface was analyzed to determine whether its use as a rinse aid or water removal composition is more effective than control products with known efficacy. Stainless steel panels were utilized as the test surface, as they are representative in testing of various surfaces and produce predictable results to create a baseline of performance.

The water removal composition analyzed is summarized by the following formula:

| Description | Qty (%) |
|---|---|
| Carspray 300 (Evonik) | 20-35 |
| Mineral Seal Oil | 20-35 |
| Butyl Cellosolve | 5-12 |
| Tomamine ™ E-14-5 (Air Products) | 0-5 |
| Tomamine ™ E-17-5(Air Products) | 0-5 |
| Tomamine ™ E-DT-3 | 2-7 |
| Dow Corning 200 Fluid 350 CST | 1-10 |
| Glacial acetic acid | 0-2 |
| DI Water | 5-30 |

Stainless steel test plates were first cleaned with an alkaline detergent (such as a 1:100 solution of Ecolab® Blue Coral Hi pH 3688) and a sponge and then rinsed with warm to hot water and finally rinsed with deiodinized water. The panels were then dried with a lint-free towel and air dried. The stainless steel test plates were then submerged in a detergent-laced solution. The panels were submerged into a container with 1:5000 solution of Ecolab® Blue Coral Hi pH 3692 with 17 grain water for 5 seconds. The water hardness was checked with a water titration kit. The panels were removed from the solution and the weight of the solution on the panel was measured. The panel was dipped into a second container with the water removal composition according to the invention blended in a 1:750 concentration with 17 grain water for 2 seconds before being withdrawn from the second container. The panels were allowed to drip over the container for 8 seconds. After removing the panel, the weight of the solution was again measured to determine the amount of water removed and the percentage of water remaining.

The results of the water removal composition according to the invention were compared to Blue Coral Cold Wax, which is used as a benchmark composition for water removal. The same procedure was used to test Blue Coral Cold Wax at a 1:400 concentration as baseline. The results were also compared to a competitive product, CSI® drying agent Lustra Pearl®. Tests were also repeated using 0 grain (“soft”) water. The results indicate that the water removal composition according to the invention removed more water from the treated surfaces at both 17 gpg water and 0 gpg water than both the control (Blue Coral Cold Wax) and the competitive product. The water removal composition resulted in lower percentages of water remaining, indicating better liquid removal from the panel surfaces.

### Example 2

PANEL SHEETING TEST: The ability of a water removal composition for use as a drying agent was tested to determine its effectiveness for use in an automated car wash (tested composition described in Example 1).

A stainless steel panel was cleaned using a sponge, Ecolab® Blue Coral Hi pH 3688 (full strength) and 0 grain water. The panels demonstrate full sheeting for a few seconds during the rinse of the cleaning step. Then a deiodinized water rinse was completed and panels were dried completely. The stainless steel panel was held at a 5° incline. The surface was then treated with a stream of a detergent-laced solution, specifically a 1:3000 solution of Ecolab® Blue Coral Hi pH 3692 and 17 grain water from a rain bar to coat the panel. The surface was treated with the solution from the elevated end to ensure that the entire surface was wet. The panel surface was then immediately sprayed with approximately 3 mL of the water removal composition at a concentration of 1:750 sufficient to cover the entire panel. The test panels were then rinsed under a stream of water for 3 seconds to simulate an automated car wash rain bar. The results were visually evaluated at 5 seconds and 15 seconds after rinsing to record the percentage of the panel that remained wet and to grade the panel for water droplets remaining on the panel surface.

The panels were then washed using a sponge and Ecolab® Blue Coral Hi pH 3688 in soft water and then rinsed thoroughly with soft water. The panels were observed for sheeting on panel for approximately 3 seconds to verify chemicals were removed. The panels were then rinsed with deiodinized water and dried completely.

The results of the water removal composition according to the invention were compared to Cold Wax (1:400 concentration), used as a benchmark composition for water removal. The results were also compared to a competitive product, CSI® drying agent Lustra Pearl®. Tests were also repeated using 0 gpg water. The results demonstrated that the water removal composition according to the invention removed more water from the treated surfaces at both 17 gpg water and 0 gpg water than both the control (Blue Coral Cold Wax) and the competitive product. The water removal composition resulted in lower percentages of water remaining, indicating better liquid removal from the panel surfaces.

What is claimed:

1. A composition comprising:
a silicone polymer and quaternary ammonium emulsifier to cause beading of water on a surface; and
a co-emulsifier and an HLB stabilizing agent to form a microemulsion.

2. The composition of claim 1, wherein the silicone polymer is a member selected from the group consisting of polydimethyl siloxane, polysiloxane copolymer, polyalkylene oxide-modified polydimethylsiloxane, polybetaine-modified polysiloxane and combinations of the same.

3. The composition of claim 1, wherein said quaternary ammonium emulsifier is a cationic dicoco.

4. The composition of claim 1, wherein said co-emulsifier is an ethoxylated amine.

5. The composition of claim 1, wherein said HLB stabilizing agent is a tallow diamine.

6. The composition of claim 1 having a use concentration between about 0.1% to 1%.

7. The composition of claim 1 having a use concentration between about 0.125% to 0.4%.

8. The composition of claim 1 having a pH from between 5 to 8.

9. A composition for removing water from a surface comprising:
a silicone polymer, quaternary ammonium emulsifier, ethoxylated amine and tallow diamine, said composition forming a microemulsion having a use concentration of between about 0.167% to 0.250%.

10. A method for water removal from a surface comprising:
contacting a surface with a composition capable of removing excess water from a surface, said composition comprising a silicone polymer, quaternary ammonium emulsifier, co-emulsifier and an HLB stabilizing agent; and
creating a hydrophobic surface to cause removal of water from said surface.

11. The method of claim 10, wherein said water has a hardness up to about 15 gpg.

12. The method of claim 10, wherein said silicone polymer is a member selected from the group consisting of polydimethyl siloxane, polysiloxane copolymer, polyalkylene oxide-modified polydimethylsiloxane, polybetaine-modified polysiloxane and combinations of the same.

13. The method of claim 10, wherein said quaternary ammonium emulsifier is a cationic dicoco.

14. The method of claim 10, wherein said emulsifier is an ethoxylated amine.

15. The method of claim 10, wherein said stabilizing agent is a tallow diamine.

16. The method of claim 10, wherein said composition is stored in a multi-chamber prior to administration to said surface to ensure stability of said silicone polymer in a microemulsion.

17. The method of claim 10, wherein the surface is selected from the group consisting of painted metal, metal, glass, rubber, plastic and combinations of the same.

18. The method of claim 17, wherein said composition is applied to said surface after wash or before or during a finishing rinse step of a car wash.

19. The method of claim 18, wherein said composition is applied in a use concentration of about 0.125% to 0.4%.

20. The method of claim 18, wherein said composition is applied in a use concentration of about 0.167% to 0.250%.

21. The method of claim 18, wherein the surface is any exterior vehicle surface.

22. The method of claim 10, further comprising creating a continuous hydrophobically active layer on said surface to promote water removal from said surface with minimal or no requirement for air blowers.

23. A method of removing water from a vehicle surface comprising:
contacting a wet surface with a microemulsion composition comprising a silicone polymer, quaternary ammonium emulsifier, co-emulsifier and stabilizing agent;
permitting said composition to penetrate any residual foam or soap on said surface;
creating a hydrophobic layer on top of said surface; and
causing water coming into contact with said surface to bead off said surface.
